(19) United States
(12) Patent Application Publication
(10) Pub. No.: US 2020/0151591 A1
(43) Pub. Date: May 14, 2020

(54) INFORMATION EXTRACTION FROM DOCUMENTS

(71) Applicant: MOCSY INC., Toronto (CA)

(72) Inventor: Jasper LI, Toronto (CA)

(21) Appl. No.: 16/481,999

(22) PCT Filed: Jan. 29, 2018
(86) PCT No.: PCT/IB2018/050533

§ 371 Date: Jul. 30, 2019

Related U.S. Application Data
(60) Provisional application No. 62/452,736, filed on Jan. 31, 2017.

(51) Int. Cl. G06N 5/04; G06F 16/93; G06F 16/35; G06N 20/00

(52) U.S. Cl. CPC G06N 5/04; G06N 20/00; G06F 16/35; G06F 16/93

(57) ABSTRACT

There is provided a method including sending a first document to a GUI, and receiving at a classification and extraction engine (CEE) from the GUI an input indicating first document data for the first document. The input forms a portion of a dataset. A prediction is generated at the CEE of second document data for a second document using a machine learning model (MLM) configured to receive an input and generate a predicted output. The MLM is trained using the dataset, the input includes one or more tokens corresponding to the second document. The output includes the prediction of the second document data. The prediction is sent to the GUI, and feedback on the prediction is received at the CEE from the GUI, to form a reviewed prediction. The reviewed prediction is added to the dataset to form an enlarged dataset, and the MLM is trained using the enlarged dataset.

### CROSS-REFERENCE TO RELATED APPLICATION

This application claims the benefit of U.S. Provisional Patent Application No. 62/452,736, filed on Jan. 31, 2017, which is incorporated herein by reference in its entirety.

### FIELD

The present specification relates to systems and methods for information extraction from documents.

### BACKGROUND

Data can be formatted and exchanged in the form of documents. As the volumes of data and the frequency of data exchanges increase, the number of documents generated and exchanged may also increase. Computers can be used to process documents.

### SUMMARY

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

According to an aspect of the present specification, there is provided a method comprising: sending a first document from a set of documents to a graphical user interface (GUI); receiving at a classification and extraction engine (CEE) from the GUI an input indicating for the first document first document data, the input forming at least a portion of a training dataset; generating at the CEE a prediction of second document data for a second document from the set of documents, the prediction generated using a first machine learning model configured to receive a first input and in response generate a first predicted output, the first machine learning model trained using the training dataset, and wherein the first input comprises one or more computer-readable tokens corresponding to the second document and the first predicted output comprises the prediction of the second document data; sending the prediction from the CEE to the GUI; receiving at the CEE from the GUI feedback on the prediction to form a reviewed prediction; at the CEE adding the reviewed prediction to the training dataset to form an enlarged training dataset; and at the CEE training the first machine learning model using the enlarged training dataset.

The method can further comprise before the sending the first document to the GUI: importing at a document preprocessing engine the first document and the second document, the document preprocessing engine comprising a document preprocessing processor in communication with a corresponding memory; and preprocessing the first document and the second document at the document preprocessing engine to form preprocessed documents, the preprocessing configured to at least partially convert contents of the first document and the second document into computer-readable tokens.

The first document data can comprise one or more of a document type of the first document, one or more document fields in the first document, and one or more field values corresponding to the document fields; and the second document data can comprise one or more of a corresponding document type of the second document and one or more corresponding field values for the second document.

The method can further comprise: forming an updated CEE by adding a second machine learning model to the CEE, the second machine learning model configured to accept a second input and in response generate a second predicted output, the updated CEE formed such that the second input comprises at least the first predicted output and the second predicted output comprises document data.

The document data can comprise one or more of a corresponding document type of the second document and one or more corresponding field values for the second document.

The second machine learning model can have a maximum prediction accuracy corresponding to the enlarged training dataset that is larger than a corresponding maximum prediction accuracy of the first machine learning model corresponding to the enlarged training dataset.

The second machine learning model can be selected based on a size of the enlarged training dataset.

The method can further comprise: forming an updated CEE by adding a second machine learning model to the CEE, the second machine learning model configured to accept a second input and in response generate a second predicted output, the updated CEE formed such that the second input comprises at least the first predicted output and the second predicted output comprises document data; determining whether an accuracy score determined at least partially based on the second predicted output exceeds a given threshold; and if the accuracy score does not exceed the given threshold, forming a further updated CEE by adding a third machine learning model to the updated CEE, the third machine learning model configured to accept a third input and in response generate a third predicted output, the further updated CEE formed such that the third input comprises at least the second predicted output and the second predicted output comprises corresponding document data.

The given threshold can comprise one of: a corresponding accuracy score determined at least partially based on the first predicted output; and a given improvement to the corresponding accuracy score.

The second input can further comprise one or more computer-readable tokens corresponding to the second document.

The method can further comprise training the updated CEE using a further training dataset by training the first machine learning model using the further training dataset without training the second machine learning model using the further training dataset.

The method can further comprise: forming a further updated CEE by adding a third machine learning model to the updated CEE, the third machine learning model configured to accept a third input and in response generate a third predicted output, the further updated CEE formed such that the second input further comprises the third predicted output.

The first machine learning model can comprise one of a neural network, a support vector machine, a genetic program, a Kohonen type self-organizing map, a hierarchical Bayesian cluster, a Bayesian network, a Naïve Bayes classifier, a support vector machine, a conditional random field, a hidden markov model, a k-nearest neighbor model, and a multiple voting model.

The first machine learning model can be further configured to generate a confidence score associated with the first predicted output; and the method can further comprise, at the CEE: designating the prediction for review by an expert reviewer if the confidence score is below a threshold; and designating the prediction for review by a non-expert reviewer if the confidence score is at or above the threshold.

The first machine learning model can be selected from a plurality of machine learning models ranked based on prediction accuracy as a function of a size of the training dataset, the first machine learning model selected to have a highest maximum prediction accuracy corresponding to a size of the training dataset among the plurality of machine learning models.

The method can further comprise: determining whether another set of documents is of the same document type as the set of documents; and if the determination is affirmative, training a fourth machine learning model using at least a portion of another training dataset associated with the other set of documents and at least a portion of the enlarged training dataset, the other training dataset comprising one or more of a corresponding document type and corresponding field values associated with the other set of documents, the fourth machine learning model configured to receive a fourth input and in response generate a fourth predicted output, the fourth input comprising one or more computer-readable tokens corresponding to a target document from one of the set of documents and the other set of documents and the fourth predicted output comprising a corresponding prediction of corresponding document data for the target document.

The determining whether the other set of documents is of the same document type as the set of documents can comprise: generating a test predicted output using the first machine learning model based on a test input comprising one or more computer-readable tokens corresponding to a test document from the other set of documents; generating a confidence score associated with the test predicted output; generating a further test predicted output using a third machine learning model trained using at least a portion of the other training dataset associated with the other set of documents, the further test predicted output generated based on a further test input comprising one or more corresponding computer-readable tokens corresponding to a further test document from the set of documents; generating a further confidence score associated with the further test predicted output; determining whether the confidence score and the further confidence score are above a predetermined threshold; and if the determination is affirmative, designating the other set of documents as being of the same document type as the set of documents.

According to another aspect of the present specification, there is provided a method comprising: receiving a document at a classification and extraction engine (CEE), the CEE comprising a CEE processor in communication with a memory, the memory having stored thereon a first machine learning model executable by the CEE processor, the first machine learning model configured to accept a first input and in response generate a first predicted output; generating at the CEE a prediction of one or more of document type and field values for the document, the predictions generated using the first machine learning model wherein the first input comprises one or more computer-readable tokens corresponding to the document and the first predicted output comprises the prediction of one or more of the document type and the field values for the document; sending the prediction from the CEE to a graphical user interface (GUI); receiving at the CEE from the GUI feedback on the prediction to form a reviewed prediction; at the CEE adding the reviewed prediction to a training dataset; selecting at the CEE a second machine learning model configured to accept a second input and generate a second predicted output, the second machine learning model having a maximum prediction accuracy corresponding to the training dataset that is larger than a corresponding maximum prediction accuracy of the first machine learning model corresponding to the training dataset; and forming an updated CEE by adding the second machine learning model to the CEE such that the second input comprises at least the first predicted output and the second predicted output comprises one or more of the document type and the field values.

According to another aspect of the present specification, there is provided a non-transitory computer-readable storage medium comprising instructions executable by a processor, the instructions configured to cause the processor to perform any one or more of the methods described herein.

According to another aspect of the present specification, there is provided a system comprising: a classification and extraction engine (CEE) comprising a CEE processor in communication with a memory, the memory having stored thereon a first machine learning model executable by the CEE processor, the first machine learning model configured to accept a first input and in response generate a first predicted output; the CEE configured to: receive from a Graphical User Interface (GUI) an input indicating first document data for a first document from a set of documents, the input forming at least a portion of a training dataset; generate a prediction of second document data for a second document from the set of documents, the prediction generated using the first machine learning model trained using the training dataset and wherein the first input comprises computer-readable tokens corresponding to the second document and the first predicted output comprises the prediction of the second document data; send the prediction to the GUI; receive from the GUI feedback on the prediction to form a reviewed prediction; add the reviewed prediction to the training dataset to form an enlarged training dataset; and train the first machine learning model using the enlarged training dataset.

The system can further comprise: a document preprocessing engine comprising a document preprocessing processor in communication with the memory, the document preprocessing engine configured to: import the first document and the second document; and process the first document and the second document to form preprocessed documents, the preprocessing configured to at least partially convert contents of the first document and the second document into computer-readable tokens.

The first document data can comprise one or more of a document type of the first document, one or more document fields in the first document, and one or more field values corresponding to the document fields; and the second document data can comprise one or more of a corresponding document type of the second document and one or more corresponding field values for the second document.

The CEE can be further configured to: add a second machine learning model to the CEE, the second machine learning model configured to accept a second input and in response generate a second predicted output, the second input comprising at least the first predicted output and the second predicted output comprising document data.

The document data can comprise one or more of a corresponding document type of the second document and one or more corresponding field values for the second document.

The second machine learning model can have a maximum prediction accuracy corresponding to the enlarged training dataset that is larger than a corresponding maximum prediction accuracy of the first machine learning model corresponding to the enlarged training dataset.

The second machine learning model can be selected based on a size of the enlarged training dataset.

The CEE can be further configured to: add a second machine learning model to the CEE to form an updated CEE, the second machine learning model configured to accept a second input and in response generate a second predicted output, the second input comprising at least the first predicted output and the second predicted output comprising document data; determine whether an accuracy score determined at least partially based on the second predicted output exceeds a given threshold; and if the accuracy score does not exceed the given threshold, add a third machine learning model to the updated CEE, the third machine learning model configured to accept a third input and in response generate a third predicted output, the third input comprising at least the second predicted output and the second predicted output comprising corresponding document data.

The given threshold can comprise one of: a corresponding accuracy score determined at least partially based on the first predicted output; and a given improvement to the corresponding accuracy score.

The second input can further comprise the computer-readable tokens corresponding to the second document.

The CEE can be further configured to train the first machine learning model using a further training dataset without training the second machine learning model using the further training dataset.

The CEE can be further configured to: add a third machine learning model to the CEE, the third machine learning model configured to accept a third input and in response generate a third predicted output, the second input further comprising the third predicted output.

The first machine learning model can comprise one of a neural network, a support vector machine, a genetic program, a Kohonen type self-organizing map, a hierarchical Bayesian cluster, a Bayesian network, a Naïve Bayes classifier, a support vector machine, a conditional random field, a hidden markov model, a k-nearest neighbor model, and a multiple voting model.

The first machine learning model can be further configured to generate a confidence score associated with the first predicted output; and the CEE can be further configured to: designate the predictions for review by an expert reviewer if the confidence score is below a threshold; and designate the prediction for review by a non-expert reviewer if the confidence score is at or above the threshold.

The memory can have stored thereon a plurality of machine learning models ranked based on prediction accuracy as a function of a size of the training dataset; and the first machine learning model can be selected from the plurality of machine learning models to have a highest maximum prediction accuracy corresponding to a size of the training dataset among the plurality of machine learning models.

The CEE can be further configured to: determine whether another set of documents is of the same document type as the set of documents; and if the determination is affirmative, train a fourth machine learning model using at least a portion of another training dataset associated with the other set of documents and at least a portion of the enlarged training dataset, the other training dataset comprising one or more of a corresponding document type and corresponding field values associated with the other set of documents, the fourth machine learning model configured to receive a fourth input and in response generate a fourth predicted output, the fourth input comprising one or more computer-readable tokens corresponding to a target document from one of the set of documents and the other set of documents and the fourth predicted output comprising a corresponding prediction of corresponding document data for the target document.

To determine whether the other set of documents is of the same document type as the set of documents, the CEE can be further configured to: generate a test predicted output using the first machine learning model based on a test input comprising one or more computer-readable tokens corresponding to a test document from the other set of documents; generate a confidence score associated with the test predicted output; generate a further test predicted output using a third machine learning model trained using at least a portion of the other training dataset associated with the other set of documents, the further test predicted output generated based on a further test input comprising one or more corresponding computer-readable tokens corresponding to a further test document from the set of documents; generate a further confidence score associated with the further test predicted output; determine whether the confidence score and the further confidence score are above a predetermined threshold; and if the determination is affirmative, designate the other set of documents as being of the same document type as the set of documents.

### BRIEF DESCRIPTION OF THE DRAWINGS

FIG. 1 shows a schematic representation of example documents.

FIG. 2 shows a schematic representation of an example computing system for processing documents.

FIG. 3 shows a flowchart representing an example method for processing documents.

FIG. 4 shows a graph of accuracy as a function of training set size for machine learning models.

FIG. 5 shows a schematic representation of an example combination of machine learning models.

FIG. 6 shows a schematic representation of another example combination of machine learning models.

FIG. 7 shows schematic representations of two example relationships between two document classes.

FIG. 8 shows a flowchart representing another example method for processing documents.

FIG. 9 shows a schematic representation of an example computer-readable storage medium having stored thereon instructions for processing documents.

### DETAILED DESCRIPTION

Documents can be structured, freeform or unstructured, or a combination of both. Using the systems and methods described herein, document fields can be designated in structured, unstructured, and combined structured and unstructured documents, and then field values can be extracted from those designated document fields, as described in greater detail below. A structured document can comprise one or more document fields positioned at predeterminable positions on the document. For example, some forms can be structured. A freeform or unstructured document may not have document fields positioned at predeterminable positions on the document. For example, a letter can be freeform. Some documents may comprise both structured and unstructured portions.

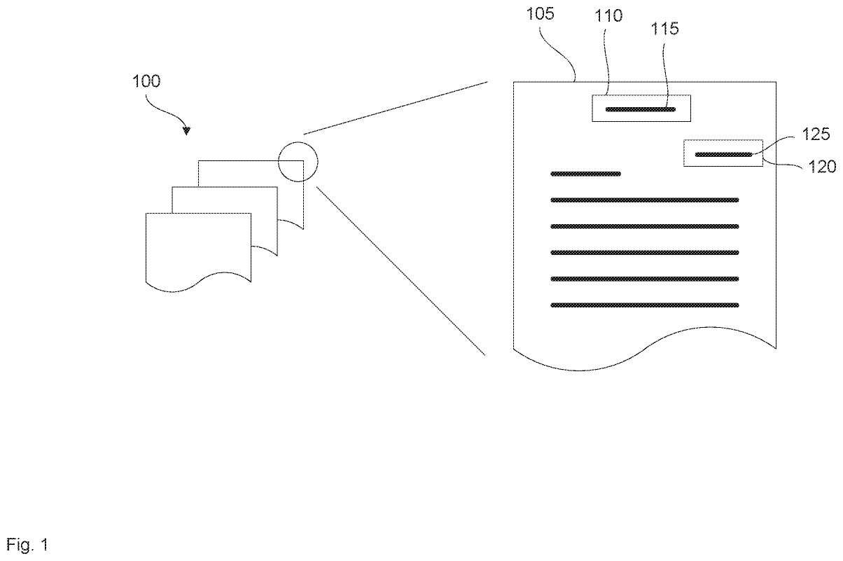

FIG. 1 shows a schematic representation of a set of documents 100, and a magnified portion of an example first document 105 from set of documents 100. First document 105 can comprise a document field 110 having a field value 115. For example, field value 115 can comprise a title or letterhead of first document 105. In addition, first document 105 can comprise a second document field 120 having a field value 125. For example, field value 125 can comprise a date of first document 105. First document 105 can also comprise other document fields (not shown) having corresponding field values. Processing first document 105 to obtain one or more of field values 115 and 125 and be referred to as data extraction, information extraction, or document field value extraction from first document 105.

In some examples, extraction of field values from a document can comprise finding some or all instances of a predefined document field in a document and returning structured data that contains some or all such instances for each field. For example, a document can be processed to extract specific field values from the document which can include, but is not limited to, a building lease (e.g. lessee, lessor, monthly rent, early termination clause, and the like), an application for a new bank account (e.g. applicant name, annual income, and the like), and the like. These document fields may be specific to a set of documents (e.g. leasing documents, bank documents, etc.) and need not be equivalent to the document fields in another set of documents, even if they might be in a similar field such as leasing or finance.

First document 105 can also have a document type. For example, the document type can comprise final notice, approval letter, and the like. Document type can also be referred to as document class. In some examples, the textual content of first document 105, including one or more of the document fields and their field values, can be used to determine the document type. For example, a title field value 115 in document field 110 can be used to determine the type of first document 105. In some examples, some or all of the content of a document, including some or all of the text of the document, from one or more of the pages of the document, can be used to determine the type of the document. Processing first document 105 to obtain the type of first document 105 can be referred to as classification of first document 105.

There can be many different types of documents. Even within a given document type, there may be variations due to versions of that document type and document and/or image processing such as Optical Character Recognition (OCR). Machine learning models (MLMs) can be used to process such diverse documents to classify the documents and/or to extract field values from the document fields in the documents.

MLMs can be configured to receive a computer-readable or machine-readable input and in response produce a predicted output. For example, the input can comprise one or more computer-readable tokens corresponding to first document 105 and the predicted output can comprise a classification (i.e. the document type) of first document 105 and/or one or more field values 115 and 125 extracted from first document 105. In some examples, these computer-readable tokens can also be referred to as computer-readable text tokens.

Examples of MLMs include a neural network, a support vector machine, a genetic program, a Kohonen type self-organizing map, a hierarchical Bayesian cluster, a Bayesian network, a Naïve Bayes classifier, a support vector machine, a conditional random field, a hidden markov model, a k-nearest neighbor model, a multiple voting model, and the like.

Before commencing document classification and/or field value extraction, such MLMs can be trained using training datasets corresponding to the specific document type and/or extraction tasks that the MLM is to perform. In some instances, such datasets may not be available. In other instances, the time used to train the MLM using a training dataset may delay the use of the MLM in performing classification and/or value extraction tasks.

More complex MLMs may use larger training datasets and/or longer training time to approach a target prediction accuracy. In some examples, complexity of an MLM may be a function of numbers of input features, increasingly complex architectures (e.g. fully connected, convolutional, recurrent neural networks) and increasing size (e.g. both number of layers and size of layers in the case of neural networks). For example, a simple model may comprise a neural network with one fully connected hidden layer, one fully connected output layer and term frequency-inverse document frequency bag-of-words (TF-IDF BOW) inputs. Correspondingly, an example complex model may comprise a neural network with several bi-directional recurrent hidden layers, one or more fully connected hidden layers, and all available features for each character as inputs.

In some instances the MLM may be overly complex relative to the size of the training dataset and/or the complexity of the classification and/or extraction tasks. Such complex MLMs may use a long time and/or a large training dataset to train, without producing a commensurate increase in the accuracy of their classification and/or extraction performance. In other words, in such cases a simpler MLM, which would be faster to train and/or use a smaller dataset to train, would produce a similar classification and/or extraction accuracy as the complex MLM.

Furthermore, in some instances the MLM may be overly simplistic relative to the size of the training dataset and/or the complexity of the classification and/or extraction tasks. Such simple MLMs may fail to produce the classification and/or extraction accuracy that would be provided by a more complex MLM.

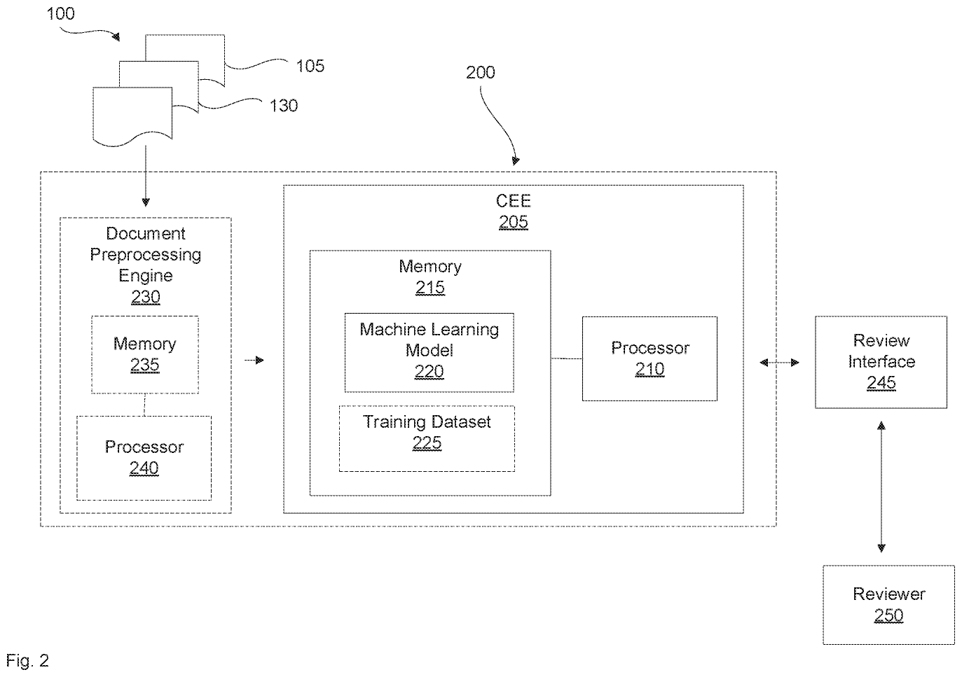

FIG. 2 shows a schematic representation of a system 200, which can be used to perform document classification and/or document field value extraction, and can address some or all of the above challenges. System 200 can comprise a classification and extraction engine (CEE) 205, which in turn can comprise a CEE processor 210 in communication with a memory 215. CEE processor 210 can comprise a central processing unit (CPU), a graphics processing unit (GPU), a microcontroller, a microprocessor, a processing core, a field-programmable gate array (FPGA), a set of processors in a cloud computing scheme, a quantum computing processor, or similar device capable of executing instructions. Processor 210 may cooperate with the memory 215 to execute instructions. It is contemplated that CEE 205 can only classify documents, only extract values from documents, or both classify and extract values from documents.

Memory 215 may include a non-transitory machine-readable storage medium that may be an electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, and the like. The machine-readable storage medium may be encoded with executable instructions.

Moreover, memory 215 may store a first MLM 220 executable by processor 210. MLM 220 can accept a first input and in response generate a first predicted output. Memory 215 can also store a training dataset 225, which can be used to train and/or retrain MLM 220. In FIG. 2, training dataset 225 is depicted in dashed lines to signify that in some examples memory 215 need not include training dataset 225. For example, as described in greater detail below, in some examples initially memory 215 may store no training dataset, and may collect and/or compile such a dataset as CEE 205 starts and continues to process documents. In other examples, training dataset 225 can be stored outside system 200 or inside system 200 outside memory 205.

System 200 can be in communication with a review interface 245. Review interface 245 can in turn be in communication a reviewer 250. In some examples, CEE 205 can be in communication with reviewer 250 via review interface 245. CEE 205 can send a predicted output to review interface 245 where the predicted output can be reviewed by reviewer 250. The review can comprise, for example, a confirmation/verification, a rejection, an alteration, and/or a correction of the predicted output. In some examples, upon review reviewer 250 can provide feedback on the predicted output.

Review interface 245 can comprise a communication interface, an input and/or output terminal, a Graphical User Interface (GUI), and the like. Reviewer 250 can comprise a computing system configured to review the predicted output. In some examples, this computing system can comprise a MLM different than MLM 220, or MLM 220 trained using a dataset different than training dataset 225. Moreover, in some examples a human reviewer can perform exception handling in conjunction with the computing system. In yet other examples, reviewer 250 can comprise a human reviewer.

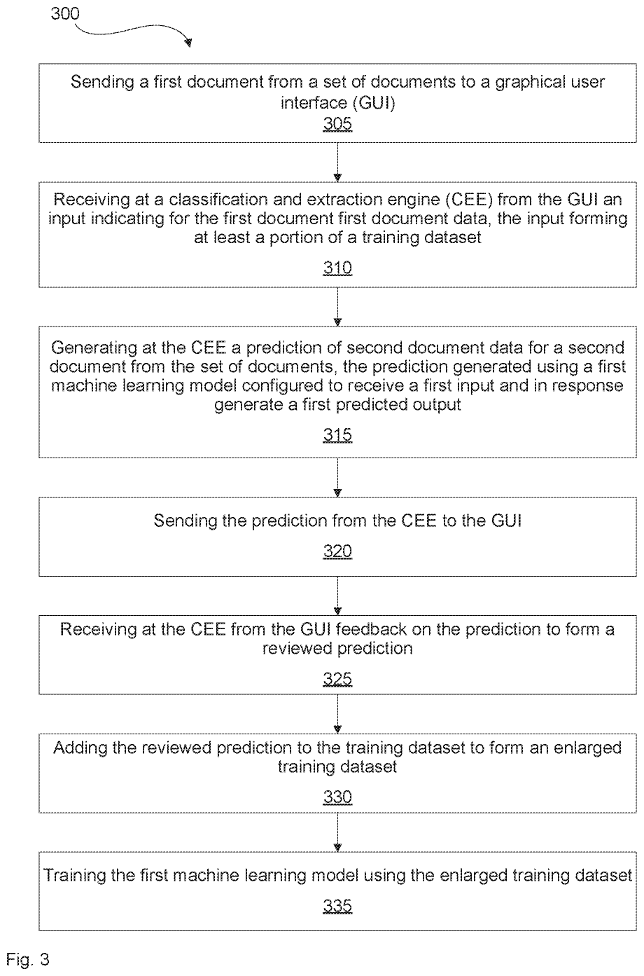

Turning now to FIG. 3, a flowchart is shown representing a method 300 for processing documents. Method 300 can be used to classify documents by determining document type and/or to extract field values from documents. Method 300 can be performed using system 200. As such, method 300 and the operation of system 200 will be described together. However, it is contemplated that system 200 can be used to perform operations other than those described in method 300, and that method 300 can be performed using systems other than system 200.

At box 305, first document 105 (shown in FIG. 1) from a set of documents 100 can be sent to a GUI. In other examples, document 105 can be sent to a type of review interface 245 other than a GUI. Document 105 can be in digital form, and in some examples, can undergo some quality enhancements or other processing prior to being sent to review interface 245 and/or the GUI.

As shown in box 310, CEE 205 can receive from the GUI an input indicating for first document 105 first document data. In some examples, first document data can comprise one or more of a document type of first document 105, one or more document fields 110, 120 in first document 105, and one or more field values 115, 125 corresponding to document fields 110, 120. It is contemplated that first document 105 can comprise one, three, or another number of fields which may be different than document fields 110, 120. In examples where reviewer 250 comprises a human reviewer, the input can comprise an identification by the human user of one or more of the document type, document fields, and/or field values for the document fields.

The input can form at least a portion of training dataset 225. In examples where CEE 205 includes no training dataset at the start, the input can comprise the first data in the training dataset. Moreover, in examples where training dataset 225 comprises data prior to receiving the input, the input can be added to training dataset 225. Training dataset 225, in turn, can be used to train MLM 220 of CEE 205.

Next, as shown in box 315 CEE 205 can generate a prediction of second document data for a second document 130 from set of documents 100. The prediction can be generated using first MLM 220, which can be configured to receive a first input and in response generate a first predicted output. As described above, prior to receiving the first input, MLM 220 can be trained using training dataset 225. Moreover, the first input can comprise one or more computer-readable tokens corresponding to second document 130 and the first predicted output can comprise the prediction of the second document data. In some examples, the second document data can comprise one or more of a corresponding document type of second document 130 and one or more corresponding field values for second document 130.

Moreover, as shown in box 320, CEE 205 can send the prediction of the second document data to the GUI, or to another type of review interface 245. Furthermore, at shown in box 325, CEE 205 can receive from the GUI feedback on the prediction to form a reviewed prediction. Examples of the feedback can include a confirmation/verification, a rejection, an alteration, a correction, and the like. A reviewed prediction, in turn, can comprise for example a confirmed prediction, a corrected prediction, and the like.

In addition, as shown in box 330, CEE 205 can add the reviewed prediction to training dataset 225 to form an enlarged training dataset. Next, as shown in box 335, CEE 205 can train or retrain MLM 220 using the enlarged training dataset.

Third and additional documents from set of documents 100 can be processed using CEE 205 by repeating boxes 315, 320, 325, 330, and 335 of method 300. In some examples, the retraining shown in box 335 need not be performed during the processing of every document, and the retraining can be performed once a batch of documents has been processed. Moreover, as CEE 205 processes an increasing number of documents from set of documents 100, and MLM 220 becomes retrained on increasingly larger training dataset 225, a confidence score and/or accuracy of the predictions of MLM 220 can increase to a point where some or all of the predictions for additional documents may not be sent to review interface 245 for review.

System 200 and method 300 can be used in relation to a set of documents even if no training dataset exists for that set or type of documents. In addition, there need not be a delay in use of system 200 and method 300 due to training MLM 220. As system 200 and method 300 process documents, they build up a bespoke training dataset for the specific type and/or set of documents being processed.

Furthermore, as CEE 205, and its MLM 220, become trained on increasingly larger training datasets 225, the confidence and/or accuracy of the predictions of CEE 205 can increase, which in turn can reduce the amount of review and/or input from reviewer 250 used in processing documents. In this manner, CEE 205, and its MLM 220, can continue to learn from the additional documents being processed and reviewed. As such, CEE 205 can also be referred to as a continuous learning engine. As discussed above, in some examples the continuous learning can comprise retraining MLM 220 using an enlarged training dataset periodically and/or after a batch of documents has been processed.

Referring back to FIG. 2, system 200 may also comprise a document preprocessing engine 230, which can comprise a memory 235 in communication with a document preprocessing processor 240. Memory 235 can be similar in structure to memory 215 and processor 240 can be similar in structure to processor 210. Document preprocessing engine 230 can receive and/or import first document 105 and second document 130 and process them to form preprocessed documents. The preprocessing can be configured to at least partially convert contents of first document 105 and second document 130 into computer-readable tokens. These computer-readable tokens can, in turn, be used as inputs for MLM 220. It is contemplated that document preprocessing engine 230 can process first document 105 only, second document 130 only, both first document 105 and second document 130, and/or one or more of the other documents in set of documents 100. Moreover, preprocessing engine 230 can process documents in a serial and/or batched manner.

In some examples, documents in various common textual (e.g. word processing, HTML) and image (e.g. JPEG, TIFF) formats can be accepted by document preprocessing engine 230 via various methods such as import from a database, upload over the Internet, upload via a web-based user interface, and the like. The documents can be pre-processed using software tools to produce the following outputs that can then be saved to a database stored in memory 235 or elsewhere: document level metadata (e.g. source filename, file format, file size); high resolution renders of each page; metadata of each page (e.g. page number, page height); and textual content of the page (e.g. the location, formatting, and text of each character); and the like.

If the source document format reflows the text based on the size of the page and the page size is not specified in the source file, a pre-defined or default page size can be used. In some examples, a pre-defined parameter can comprise a user-defined parameter. For example, a pre-defined page size can comprise a user-defined page size.

If the source document contains images, the images can be converted into text using OCR software. The OCR software can return the recognized characters on the page, its bounding rectangle (i.e. coordinates of the top, bottom, left and right edges of the extent of the character), formatting (e.g. font, bold, etc.), and the confidence that the OCR software's recognition of this character was accurate. The OCR software may also recognize machine readable glyphs such as barcodes and return their character equivalents plus a flag indicating their original format (e.g. barcode).

The OCR software may also apply various image processing techniques (e.g. denoising, thresholding) or geometric transformations (e.g. deskewing, rotation, projection) to the image to improve accuracy and normalize the shape and orientation of the page. If geometric transformations were applied during OCR the bounding rectangles in the OCR data can be transformed to match the coordinate system of the original page. Alternatively, if the image occupies the entire page and there is no other textual content on the page that was not generated by OCR, the coordinate system of OCR image can replace the coordinate system of the original page. In this case, the rendered image of the page can also be transformed to match the OCR coordinate system. The OCR data may be merged with or replace existing textual content on the page based on a pre-defined setting.

The characters in a document can then be grouped into computer-readable tokens by grouping horizontally adjacent characters that are delimited by horizontal distance, whitespace, special characters such as punctuation or transitions from one class of characters to another (e.g. letters to digits). Tokens can be further grouped into lines representing multiple tokens that are aligned vertically based on the source file format or based on an analysis of the bounding rectangles of characters from OCR.

Tokens can then be enriched with additional features by analyzing the characters in each token and the tokens before and after it using various pre-defined rules or natural language processing (NLP) techniques. These features may include token formatting (e.g. bold, font, font size), character case (uppercase, lowercase, mixed case, first letter capitalized, etc.), page location (i.e. coordinates of top, bottom, left and right edges of the bounding rectangle of the token), language (i.e. English), parts of speech (i.e. noun, verb), beginning and end of sentences, beginning and end of paragraphs, named entity recognition (i.e. telephone number, person's name, country), word embeddings (e.g. word2vec), and the like.

In some examples, based on the enriched features, a token may be split into multiple tokens (e.g. “USD$100” into “USD” and “$100”) or several adjacent tokens may be merged into a single token (e.g. the tokens “A1A” followed by a space followed by “1A1” are recognized as a postal code and become a single token “A1A 1A1”).

In FIG. 2 document preprocessing engine 230 is shown in dashed lines. This is intended to indicate that in some examples system 200 may not include document preprocessing engine 230 as a component. In such examples, the document preprocessing can be performed by a component or module outside of system 200 to produce computer-readable tokens related to the documents, which tokens can then be received by system 200. In other examples, the document preprocessing functionality may be performed by CEE 205.

For similar reasons, system 200 is shown in a dashed line to indicate that system 200 may or may not include a preprocessing engine and/or the preprocessing functionality may be performed by CEE 205. In the examples where system 200 does not comprise a separate preprocessing engine, system 200 may be the same as CEE 205. Moreover, in some examples system 200 may also comprise a workflow engine (now shown), which can route and/or queue documents, tokens, and/or data between the other components of system 200 and review interface 245. In some examples, CEE 205 may also perform the functionality of the workflow engine.

As discussed above, in some examples CEE 205 can classify a document into one of a pre-defined set of document types/classes. The most recently trained MLM 220 stored in the memory 215 can be used. The input to MLM 220 can comprise all or a subset of the textual content and metadata of each page of the document. The output of this step can comprise a predicted document class and a (typically unit-less) metric for the prediction confidence. This metric for the prediction confidence can also be referred to as a confidence score.

Moreover, in some examples, based on a pre-defined setting, the various pages of a document can be separately classified as belonging to a document class. In other words, in such examples the entire document need to be classified into a single class, and different portions of the document can be classified into different classes. A page of the document can also be classified as to whether it is the first page of a document class and/or the last page of a document class. Using these page level classifications, system 200 can predict that the document actually includes multiple sub-documents that belong to one or more corresponding classes by splitting the source document before a page that is classified as the first page of a class, after a page that is classified as the last page of a class, or when the document class of a page is different from the page before it. The source document can then be split accordingly and treated as multiple independent sub-documents when processed by system 200.

To achieve a higher document classification accuracy for a given size training set than is possible using a single MLM or a fixed aggregation of MLMs, the techniques of Adaptive Model Encapsulation (described below) and Shared Model Learning (described below) can be used to construct and train the MLMs used.

In one example of the system, the MLMs used by the Adaptive Model Encapsulation and Shared Model Learning techniques may comprise a sequence of different neural network models with increasing numbers of input features, increasingly complex layer types (e.g. fully connected, convolutional, recurrent) and increasing size (both number of layers and size of layers). For example, a simple model may comprise a neural network with one fully connected hidden layer, one fully connected output layer and term frequency-inverse document frequency bag-of-words (TF-IDF BOW) inputs. Correspondingly, a complex model may comprise a neural network with several bi-directional recurrent hidden layers, one or more fully connected hidden layers, and all available features for each character as inputs.

If the system does not have a high confidence document class prediction, it may use the globally shared document classification models from Shared Model Learning to attempt to classify the document as a globally shared document class. If this produces a high confidence document class prediction, the prediction may be saved. A human reviewer can later verify this document class prediction (in some instances the prediction may not be and/or cannot be automatically accepted) and decide whether to assign the document to a different document class or create a new document class based on the global document class.

In addition, in some examples, after classifying a document or a document page, MLM 220 can then be used to classify each token (or each character if the MLM operates at the character level) in the document into one of a pre-defined set of fields for this document's document class. There may be multiple non-overlapping instances of a field within a document. The most recently trained field prediction MLM for the current document class stored in memory, such as in memory 215, can be used. In some examples, MLM 220 can comprise a MLM configured to perform both classification and field value extraction. In other examples, MLM 220 can comprise more than one separate MLMs: one or more MLMs to perform the document classification and one or more other MLMs to perform field value extraction.

In some examples, the input to the MLM can comprise all or a subset of the textual content and metadata of each page of the document. The MLMs can produce a number of outputs for each token (or character) including for each field, such as: is the token/character part of this field, is this the first token/character of an instance of the field, and is this the last token/character of an instance of the field. As a token/character can belong to multiple overlapping fields and be both the first and last token/character of an instance of a field, all of these outputs can be treated as independent binary classification outputs and multiple outputs may be considered “true” for a given token (i.e. a multi-class criterion function such as softmax need not be used). For each field, all of the tokens/characters where the output for whether a token is part of the field is above a pre-defined or adaptive threshold, can be added to the field in the order they appear in the document. These tokens/characters may or may not be contiguous. This sequence of tokens/characters may also be split into multiple non-overlapping sequences before a “first” token/character or after a “last” token/character as determined by a pre-defined or adaptive threshold on the respective outputs of the model.

The output of this step can comprise zero, one or multiple instances of a set of ordered tokens (or characters) for each field defined for this document class and a (typically unit-less) metric for the prediction confidence of each token/character in each instance of each field. This metric can also be referred to as a confidence score.

Field predictions for a document may be generated for the fields of the unverified document classification or after the document classification has been verified by a reviewer.

To achieve a higher text extraction accuracy for a given size training set than is possible using a single MLM or a fixed aggregation of MLMs, the techniques of Adaptive Model Encapsulation (described below) and Shared Model Learning (described below) can be used to construct and/or train the MLMs used.

In one example, the MLMs used by the Adaptive Model Encapsulation and Shared Model Learning techniques may comprise a sequence of different neural network models with increasing numbers of input features, increasingly complex layer types (e.g. fully connected, convolutional, recurrent) and increasing size (both number of layers and size of layers). For example, a simple model may comprise a neural network with one convolutional hidden layer, one convolutional output layer and a one-hot representation of each token as input. Correspondingly, a complex model may comprise a neural network with several bi-directional recurrent hidden layers, one or more fully connected hidden and output layers, and all available features for each character as inputs.

If the document class is associated with one or more global document classes (either detected by the system or explicitly associated by a customer), the system may generate additional field extraction predictions using the associated global model(s). If this produces a high confidence field extraction prediction that does not overlap with another prediction, the prediction may be saved. In some examples, a human user can later verify this field extraction prediction and if accepted, this field can be added to the fields for this document class. As a result, the system can present fields it has learned from other customers and/or customer groups in similar documents that the customer has not yet configured for this document class.

In addition, in some examples, instances of fields may also be classified into one of a pre-defined set of classes defined for the field; for example, an instance of a field that contains a sentence describing whether a parking spot is included in a lease could be classified as either yes or no. This can be done using machine learning techniques in a similar manner to the document classification step but using the tokens in this instance of the field and MLMs specifically trained for the classes of this field.

Once CEE 205 generates predictions about document type and/or field values, the predictions can be communicated to review interface 245 for review by reviewer 250. In some examples, documents can be sequenced in an approximately first-in-first-out order so that the total time from a document being imported into the system to the resulting data exported from the system is minimized. In some examples, as CEE 205 retrains MLM 220 using the enlarged training dataset, some predictions may be updated. As a result of such updates, a document that is waiting for review can be re-assigned to a different reviewer or a document may be automatically accepted bypassing the review. In some examples, a reviewer can be assigned to review specific document classes, in which case the system when assigning a document for review can limit the possible reviewers to those that have been configured for that document class.

As discussed above, in some examples review interface 245 can comprise a GUI. The GUI can present documents assigned to the currently logged in reviewer for review. In order to achieve the task of reviewing the predictions, the GUI can operate in various suitable configurations, of which some non-limiting examples are provided below.

The GUI may present all documents requiring document classification review assigned to the reviewer in a single screen. The documents can be grouped by document class. A thumbnail of each document with a method for viewing each document and each page of each document at higher resolution can be provided. The reviewer can accept or correct the predicted document class for each document by selecting one or more documents and selecting an accept button or selecting a different document class from a list.

The GUI may alternatively present documents one at a time, showing a large preview of the document and its pages and indicating the predicted class. The reviewer can accept the predicted class or select a different class from a list.

In some examples, field review/verification can occur as long as there is a classified document that is assigned to the reviewer to verify the extracted, i.e. predicted, field values. This can begin when initiated by the reviewer or immediately after one or more document classifications have been verified by the reviewer. For field verification, the GUI can present a single document at a time. Field predictions can be shown as a list of fields and predicted values and/or by highlighting the locations of the predicted field extractions on a preview of the document. The reviewer can add an instance of a field for extraction that was not predicted by selecting the field from a field list and selecting the tokens on the appropriate page(s) of the document using the GUI. The GUI can show the textual value of the selected tokens and the reviewer can then make corrections to this text if needed.

Similarly, the reviewer can also correct an existing prediction by selecting the prediction from the prediction list or highlighting on the document preview, selecting a new set of tokens and correcting the text if needed. The reviewer can also accept all of the predictions, corrected predictions, and/or reviewer added values by selecting a corresponding selectable “button”. This can save the field values as verified and move to the next assigned document for field extraction verification.

Although a single exemplary reviewer is described, it will be appreciated that there may be multiple reviewers, some of which can be classified as experts. In some examples, the GUI may allow the reviewer to assign a document or specific prediction to be verified by an expert reviewer or a specifically identified or named reviewer from a list.

In some examples, system 200 and/or review interface 245 can also present the option for the reviewer to split a multi-page document into multiple sub-documents by presenting each page of the document and allowing the reviewer to specify the first and last page of each sub-document and the document class of each sub-document. If the system has generated a prediction for this document splitting, it will be presented to the reviewer for correction or verification.

If a document classification prediction was altered by the reviewer, new field predictions for the document or its resulting sub-documents can be generated and then verified by the reviewer. In this case, the review interface can either require the reviewer to wait for new field predictions for verification, or queue the document for field verification after the field predictions have been generated while moving the reviewer to the next available document for field verification.

Initially, when no documents in a document class have been verified and thus there may be no training dataset or trained models available, system 200 may not produce a prediction. In this case, the system can present the reviewer with the option to select the document class of each document and select the location and correct the text of all field instances present in the document without a prediction presented.

In some examples, CEE 205 can determine whether a predicted output is to be communicated to review interface 245 for review by reviewer 250. This determination can be based on the confidence score associated with the predicted output. Moreover, in cases where CEE 205 communicates the predicted output to review interface 245 for review, CEE 205 can further designate the predicted output for review by an expert reviewer if the confidence score is below a threshold. If, on the other hand, the confidence score is above the threshold, CEE 205 can designate the predicted output for review by a non-expert reviewer.

Moreover, in some examples, an expert reviewer can comprise a reviewer that can determine the accuracy of a predicted output with higher accuracy compared to a non-expert reviewer. In addition, an expert reviewer can comprise a reviewer that can determine the accuracy of a predicted output in the case of rare and/or infrequent document types, document fields, and/or field values with a higher accuracy compared to a non-expert reviewer.

As the system's overall accuracy increases, an increasing amount of review can shift from experts to non-experts. If new document types or significantly different versions of existing types are added for which the system is less confident in its predictions, these can be preferentially sent to expert reviewers to correctly train the system.

Furthermore, in some examples Defined Error Tolerance Techniques (DETT) can be used by CEE 205 to determine whether a predicted output is sent to review interface 245 to be reviewed, and/or whether the output is designated for review by an expert or non-expert reviewer. In some examples, DETT can be used by CEE 205 to set the threshold for the confidence score, which threshold can then be used to decide whether a prediction/predicted output is to be reviewed, and/or whether the review is to be by an expert or non-expert reviewer. When CEE 205 determines, using DETT, that a review is not needed, a predicted output can be automatically accepted bypassing the review.

In one example of DETT, the confidence score associated with the verified/reviewed predictions of a MLM is analyzed. Predictions are sorted by the confidence score in decreasing order. The sorted predictions are iterated from most confident to least until the error rate of the predictions above the currently iterated prediction is equal to or less than a pre-defined target error rate; e.g. one incorrect and automatically accepted prediction in one thousand. The confidence of this prediction is selected as the confidence threshold. The confidence threshold can be adjusted with a safety factor such as selecting the confidence of a prediction a fixed number of predictions higher up in the sorted list or multiplying the threshold by a fixed percentage. In addition, in some examples a minimum population size of verified predictions can be set before which a threshold is not selected.

In another example of DETT, initially the confidence threshold is set to 100% so that all predictions are sent for review/verification. Then, the MLM such as a multi-layer fully connected neural network is trained to predict whether the prediction of a model is likely to be correct using previously-reviewed data. The input to the MLM can consist of one or more features such as: the overall prediction confidence, the values used to calculate the overall prediction confidence (e.g. start of field flag, end of field flag, part of field flag), the OCR confidence of the text in the prediction, the length of the text extracted, a bag-of-words representation of the tokens in the text extracted, and the like. The output of the MLM can comprise a binary classification of either correct or incorrect with softmax applied to normalize the output value between 0 and 100%. This accuracy predictor model can be tested against a test dataset withheld from the training dataset, or using k-fold testing. In testing, the system can find the lowest confidence threshold value of the accuracy predictor where the false positive rate is equal to or less than the target error rate. If k-fold testing is performed, the results can be averaged and a confidence interval with a system defined confidence level (e.g. 95%) can be calculated from the thresholds found from each fold. The average threshold value can be adjusted to the upper-bound of the confidence interval.

In both examples of DETT described above, the training dataset can be weighted to favor most recent data using linear or exponential decay weighting. Moreover, the accuracy predictor can be periodically retrained using all available data.

In addition, as part of DETT in some examples the following two methods can be used individually or together to help verify the validity or the accuracy predictions: first, a random sample of predictions that would have been automatically accepted can be instead sent for review and the error rate of these samples can be compared with the expected error rate. Second, where errors can be subsequently detected by a different downstream system or process, these errors can be reported back to the system. This information can be added to the accuracy training data for when the accuracy model is updated.

Since the confidence metric produced by MLMs is generally a unit-less metric that need not and/or may not correspond to an error rate (e.g. a 99% confidence need not and/or may not necessarily mean that 1% of predictions are incorrect) and indeed there may not be a linear relationship between the confidence metric and the error rate, there may be no way a priori to determine the error rate from a given confidence threshold. As a result, using a fixed or pre-defined threshold on the confidence value, above which predictions are automatically accepted, may not provide an estimate as to the error rate a given threshold value will result in. System 200 and/or CEE 205 can overcome this challenge by using DETT which can allow CEE 205 to choose and/or adjust a threshold for the confidence score which threshold then provides a target accuracy rate.

As described above, using both outputs predicted by CEE 205 and feedback from a reviewer, system 200 can be configured to provide extracted data that is at human level accuracy. In order to achieve this, the system can send all predictions for review by a human reviewer. In doing so, the accuracy of the data produced by the system can be maintained at human level quality, while reducing the amount of human effort required per document. This reduction in human effort can be achieved because the human reviewer is merely reviewing the predicted document types and field values instead of determining document type and extracting field values unaided. Moreover, as discussed above, to further reduce the amount of human reviewer effort used, the system can be configured to automatically accept certain predictions without review. In this configuration, the system can determine what predictions it can automatically accept (i.e. not use human verification) while keeping its false positive rate below the pre-defined target error rate; e.g. one incorrect and automatically accepted prediction in one thousand.

As new reviewed/verified data, i.e. document types and filed values, are collected by system 200, the data can be added to the training dataset. The MLMs can then be periodically retrained if new training data and/or an enlarged training dataset becomes available. This retaining of the MLMs can be referred to as the Continuous Learning Technique (CLT). In some examples, when training, a weighting may be applied to each instance in the training dataset that can make older training data have less importance during the training. A function such as exponential or linear decay with a cutoff after a certain age may be used.

The systems and methods described herein can use CLT, whereby data can be extracted from documents on a continuous basis while maintaining human level accuracy (or a pre-defined level of accuracy if used in conjunction with the DETT), with the system continuously and/or periodically reducing the amount of human user effort required per document over time. This system need not have, and in some examples does not have, a discrete mode intended for training the MLM that would later be used to perform productive classification and/or extraction work. The system can continue to learn and update its MLMs from data that is reviewed/verified as the system is used over time.

System 200 can add new reviewed and verified predictions to its training dataset 225. As the training set grows, it can be used to periodically retrain the MLMs. Updated models can replace the corresponding existing MLMs, and the updated MLMs can be used to generate future predictions. In some examples, existing predictions may also be regenerated using the updated models. Moreover, in some examples this cycle of updating the models may take on the order of seconds to days depending on the MLMs used, the configuration of the underlying computer system hardware, and the size of the training dataset.

As discussed above, in some examples processor 210 can comprise graphical processing units (GPU) or similar hardware designed to perform large numbers of parallel computational operations configured to retrain the MLMs using the growing enlarged training datasets.

Moreover, in some examples a separate MLM or collection of MLMs can be used for each customer for document classification and for each document class for field value extraction. In some examples, a customer can comprise an entity that uses the systems, methods, and computer-readable storage mediums described herein to classify and/or extract field values from documents. Shared Model Learning (described below) can also generate additional MLMs that are shared across multiple customers.

Trained MLMs can be saved to a database and/or to memory 215. In some examples, as new trained MLMs become available, document class and field value predictions for documents that have not yet been reviewed can be regenerated. Based on these new predictions, the prediction accuracy may be re-estimated and the document automatically accepted, if applicable.

Furthermore, in some examples, extracted field values may be post-processed to convert the raw text values into forms more suitable for use by other systems. In some examples this post-processing can be performed by a separate post-processing engine (not shown) inside or outside system 200. In other examples, the post-processing can be performed by CEE 205.

In some examples, during the post-processing strings in the text may be replaced with regular expressions or lookup tables. The text may also be normalized to common field formats such as numbers (by removing non-number characters), currency, date (by parsing a string as a date and storing the date in a standard format), postal code, and the like, by applying various suitable rules-based techniques.

In addition, in some examples system 200 can post-process documents that have been verified by reviewer 250 or automatically accepted by CEE 205 without a review, and then export the post-processed documents to a destination system. If a document was split into sub-documents or individual pages underwent geometric transformation, these can be applied to the document to produce a final version of the document or multiple sub-documents. Moreover, instances of each field can be further transformed by applying pre-defined rules or regular expressions (e.g. change text to all upper case) to make them suitable for use by subsequent systems.

System 200 can make the final document or sub-documents available as individual files in a standardized format that preserves the layout of the pre-processed document (e.g. PDF). The field instance data and document metadata can be made available as structured data (e.g. XML, JSON). These can be transferred to other systems by various methods including saving to files in a disk or network location, making the files available on the internet, returning the files in response to an API call, pushing the files to another system via API calls or exporting the data directly to a database.

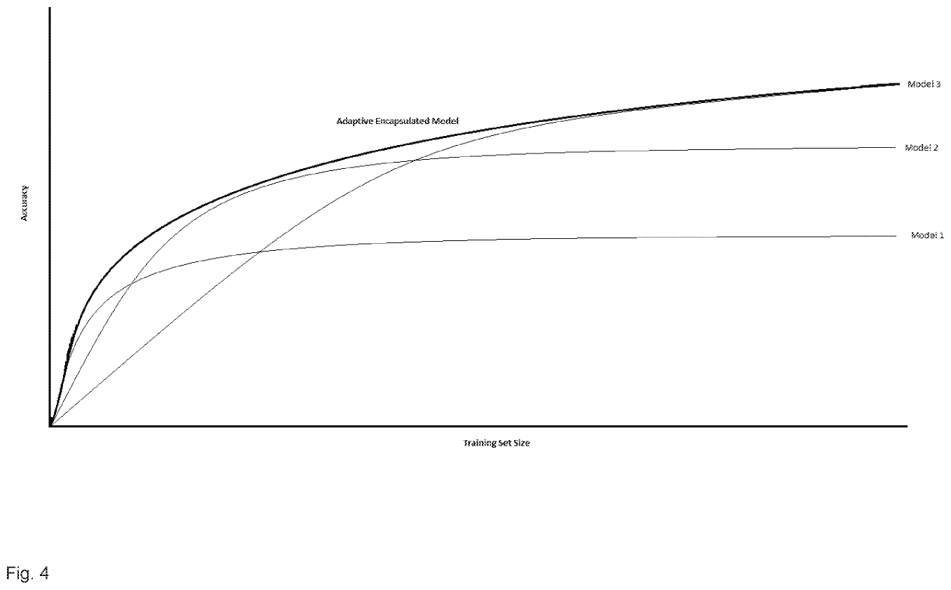

Turning now to FIG. 4, a graph of accuracy vs. size of training dataset is shown for three different MLMs labeled model 1, model 2 and model 3. Various MLMs can have different tradeoffs of classification accuracy for a given size training dataset and computer processing resources and time required to train and evaluate. In general, more powerful MLMs that utilize a greater number of input features and have a larger number of trainable parameters can achieve a higher accuracy but require larger training datasets to approach their maximum accuracy. In deciding to use a particular MLM, the maximum achievable accuracy for a given training dataset size is fixed a priori. In general, the accuracy of a given MLM will approach an asymptotic maximum value for a given size training dataset, where simpler models will reach a lower maximum asymptotic accuracy, but approach the asymptote sooner than more complex models, as shown in FIG. 4.

In FIG. 4, the simplest model, model 1, approaches its asymptotic maximum accuracy relatively quickly. Compared to model 1, the most complex model (i.e. model 3), requires a much larger training dataset size to approach its asymptotic maximum accuracy; however, the maximum accuracy of the more complex model 3 is larger than the maximum accuracy of the relatively simpler model 1. Model 2 can be of medium complexity, and have a maximum accuracy between that of model 1 and model 3. The thicker line labeled Adaptive Encapsulated Model can represent the accuracy of a combination of two or more of models 1, 2, and 3. This combination MLM can also be referred to as an adaptive encapsulated MLM. The adaptive encapsulated MLM increases the model complexity commensurate with the training dataset size and/or the complexity of the classification/extraction task, and by doing so can achieve higher accuracy levels at a given training set size when compared to models 1, 2, and 3.

Adaptive Model Encapsulation Techniques (AMET) described herein can improve upon choosing a model a priori by adaptively selecting and combining multiple MLMs in order to achieve a higher accuracy with a given size training dataset than is possible using a fixed MLM. In doing so, the system can achieve both high accuracy using large and complex MLMs on large training datasets while still providing useful accuracy when training datasets are small and simpler MLMs often outperform complex ones that tend to overfit. In addition, by selecting a simpler subset of MLMs when training datasets are smaller, the amount of computer processing time, processing power, and memory required to train the MLMs can be reduced.

AMET can be combined with CLT to continuously select a better combination of MLMs as the size of the training dataset changes.

In an example employing the AMET, a number of reference MLMs can be selected in advance. These can belong to different families of machine learning techniques. For illustrative purposes, different classes of neural networks are used as examples herein.

A number of reference models can be configured into the system a priori. The models can be sorted, where the MLM that is most likely to achieve the highest accuracy on a small training dataset can be selected first. The MLM that is likely to learn the next fastest while achieving a higher maximum accuracy can be selected next. This process can continue until all MLMs are sorted. The order of these MLMs can also be determined in advance or at run time by testing the accuracy of each MLM trained against a representative training dataset at varying sizes.

The MLMs may vary by machine learning technique, number of trainable parameters (e.g. number of neurons and layers in a neural network), hyperparameter settings, the subset of available input features used as input to the model and pre-defined feature engineering applied to those input features, and the like. For example, a simple MLM for a document classifier may comprise a neural network with one fully connected hidden layer, one fully connected output layer and term frequency-inverse document frequency bag-of-words (TF-IDF BOW) inputs. The second, medium complexity MLM may comprise a neural network with 3 convolutional and max pooling layers followed by 2 fully connected layers using the one-hot encoding of each document token as input. Furthermore, a high complexity MLM may comprise a neural network with several bi-directional recurrent hidden layers, one or more fully connected hidden and output layers, and most or all available features for each character as inputs.

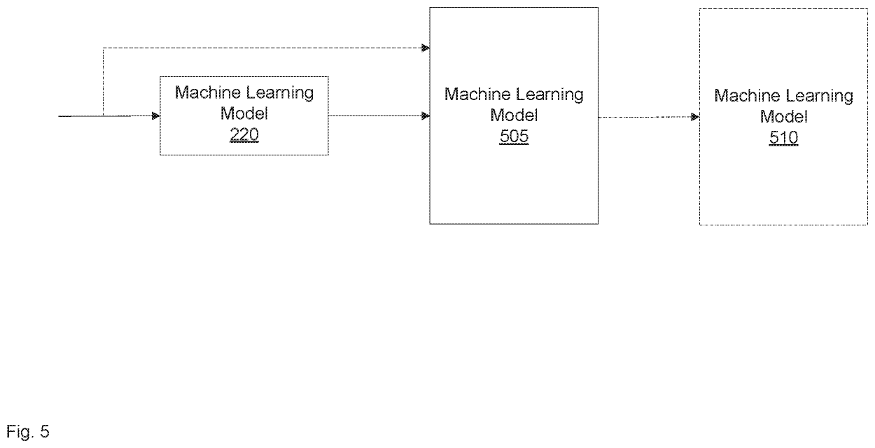

Ins some examples, an encapsulated model can be formed by chaining together one or more MLMs. This encapsulated model can form part of an updated CEE. For example, FIG. 5 shows a second MLM 505 added to and/or chained with MLM 220. MLM 505 can be configured to accept a second input and in response generate a second predicted output. The updated CEE can be formed such that the input of MLM 505 comprises at least the predicted output of MLM 220 and the predicted output of MLM 505 comprises document data. In some examples, the document data can comprise one or more of a corresponding document type of second document 130 and one or more corresponding field values for second document 130.

FIG. 5 also shows, using a dashed line, that in some examples the first input can also form part of the second input. In other words, in some examples the input for MLM 505 can comprise the output of MLM 220 as well as the input of MLM 220. In some examples, the input of MLM 505 can further comprise one or more computer-readable tokens corresponding to second document 130. These tokens can also be part of the input of MLM 220.

In some examples, MLM 505 can have a maximum prediction accuracy corresponding to the enlarged training dataset that is larger than a corresponding maximum prediction accuracy of MLM 220 corresponding to the enlarged training dataset. Moreover, in some examples, MLM 505 can be selected based on a size of the enlarged training dataset. For example, as the size of the training dataset increases from an initial size to an enlarged size, MLM 505 can be selected such that MLM 505 has a higher maximum accuracy corresponding to the enlarged dataset size than MLM 220. In some examples, when multiple MLMs are available to select from, MLM 505 can be selected to have the highest accuracy corresponding to the enlarged dataset size among the multiple available MLMs.

As discussed above, an encapsulated MLM, which can form part of an updated CEE, can comprise multiple MLMs chained together. In some examples such an updated CEE can be further trained by further training some of the MLMs in the updated CEE, while not training the other MLMs in the updated CEE. For example, the updated CEE comprising MLMs 220 and 505 chained together can be trained using a further training dataset by training MLM 220 using the further training dataset without training MLM 505 using the further training dataset. This approach to training MLMs can provide at least partial benefit of (re)training while reducing training time and computational resources that would be used for training all the MLMs in the updated CEE.

Moreover, as shown in FIG. 5, in some examples a further updated CEE can be formed by adding a third MLM 510 to the updated CEE to form a further updated CEE. Third MLM 510 can be configured to accept a third input and in response generate a third predicted output. The further updated CEE can be formed such that the input for MLM 510 can comprise the predicted output of MLM 505. In some examples (not shown), the input of MLM 510 can also comprise one or more of the input for MLM 220 and the output from MLM 220.

Referring to FIG. 5, in some examples after adding the second MLM 505, the CEE can determine whether an accuracy score determined at least partially based on the second predicted output exceeds a given threshold. The accuracy score can reflect the accuracy of one or more predictions of the CEE using MLM 220 chained together with MLM 505 as shown in FIG. 5. If the accuracy score does not exceed the given threshold, the CEE can add the third MLM 510 to the updated CEE. The CEE with MLM 510 added can be referred to as a further updated CEE. The further updated CEE can be formed such that the third input of MLM 510 comprises at least the second predicted output of MLM 505 and the second predicted output comprises corresponding document data. In this manner additional MLMs can be chained or added until the accuracy of the predictions of the encapsulated MLMs exceeds the given threshold.

In some examples, the given threshold can comprise a corresponding accuracy score determined at least partially based on the first predicted output. When the threshold is related to or at least partially reflective of the accuracy of the first predicted output generated by MLM 220, comparing the accuracy score based on or at least partially reflective of the second predicted output with the threshold can provide an indication of whether adding MLM 505 to MLM 220 has improved the accuracy of the predictions compared to using MLM 220 alone. If there has not been improvement and/or sufficient improvement, then further MLM 510 can be added in an effort to improve the accuracy score. As discussed above, additional MLMs can be added until the accuracy score of the combined or encapsulated MLM exceeds the threshold.

In some examples, the threshold is set to represent a given improvement to the corresponding accuracy score determined at least partially based on the first predicted output. Raising the threshold by the quantum of the “improvement” can allow one or more additional MLMs to be added if addition of MLM 505 does not increase the accuracy score sufficiently, i.e. by the quantum of the “improvement”, above the corresponding accuracy score determined at least partially based on the first predicted output generated using MLM 220 alone.

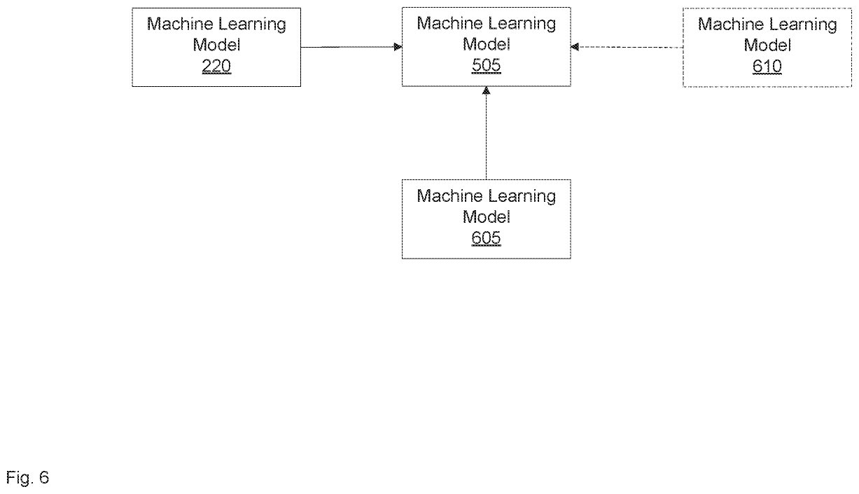

While FIG. 5 shows MLM 510 added by being chained together with MLM 505, it is contemplated that MLM 510 can be added in a different manner, for example using a hub-and-spoke scheme. FIG. 6 shows such a hub-and-spoke scheme. In FIG. 6, after chaining MLM 505 with MLM 220 as shown in and described in relation to FIG. 5, a third MLM 605 can be added such that the input for MLM 505 further comprises the output of MLM 605. In some examples, both MLM 220 and MLM 605 can receive the same input. In some examples, additional MLMs, such as a MLM 610, can also be added following the hub-and-spoke scheme.

In some examples where CEE 205 comprises one MLM 220, MLM 220 can be selected from a plurality of MLMs ranked based on prediction accuracy as a function of a size of the training dataset. MLM 220 can be selected to have a highest maximum prediction accuracy corresponding to a size of the training dataset among the plurality of MLMs.

As discussed above, in some examples MLMs ranked in order of complexity can be selected to form part of or to be added to the CEE based on the size of the training set (where each MLM has an associated threshold after which it should be used), and/or by incrementally adding increasingly complex MLMs and testing the accuracy of the encapsulated/combined model until the accuracy no longer increases. The first selected MLM can be trained using the training dataset by itself. The next selected MLM can be trained using the training dataset with the outputs from the previous MLMs also added as inputs. The previously trained MLM need not be retrained in this scheme, as it is already in a trained state. This can continue until all MLMs have been added with the output of the previous MLM feeding into the input of the next MLM. The output of the last model can be considered the output of the encapsulating/combined model; see e.g. FIG. 5.

In some examples, each MLM except the last one can be trained separately and the outputs from all MLMs except the last MLM can be fed as an input into the last MLM. In this case, the models may not be chained sequentially but rather feed into the last MLM; see for example FIG. 6. This approach can yield higher accuracy when the number of MLMs being encapsulated is large.

When used in combination with CLT, each time the MLMs are retrained, it may be possible to only retrain a subset of the encapsulated MLMs. By retraining only a subset of the simpler MLMs, the training time and/or computational resources can be reduced. This partial and/or selective MLM training can be used for example when the system is learning new types of documents it has not encountered before. By providing more frequent updates and/or retraining of the MLMs, the system can provide a larger number of predictions available for review and verification after a shorter period of time.

To further increase training speed, in some examples similarities found in documents across multiple different system instances or customer groups can be leveraged. This can have a similar effect to increasing the size of the training dataset of each instance of the system (and its one or more MLMs) to include the training data from all system instances with similar documents. This can be considered a form of what may be referred to as transfer learning where learning from other sources is used to accelerate or bootstrap the learning for a different task.

In some examples of this type of transfer leaning, a second set of documents can be found to be sufficiently similar to first set of documents 100. In such examples, the training datasets associated with the two sets of documents can be combined to form a larger, combined training dataset, which combined training dataset can be used to train a new MLM. This combining of training datasets can be referred to as Shared Model Learning (SML). In some examples, the training datasets associated with each set of documents can be partially and/or completely collected during the classification or field value extraction of documents from each set by respective MLMs.

Moreover, in some examples the similarity can be determined between two classes of documents, i.e. between a first set of documents having the same first type or first class and a second set of documents having the same second type or second class. The training datasets associated with the two classes of documents can be combined to form a larger, combined training dataset, which combined training dataset can be used to train a new MLM.

As discussed above, this new MLM, trained using the combined dataset, can have a higher prediction accuracy than a comparable MLM trained using only one of the two original training datasets. In addition to the potential for increasing prediction accuracy, such combining of training datasets can also reduce the amount of training time associated with waiting until a large training dataset is collected.

To take advantage of such combining of training datasets, it can be determined whether the second set of documents is of the same document type as set of documents 100. If the determination is affirmative, a new MLM can be trained using at least a portion of another training dataset associated with the second set of documents and at least a portion of the enlarged training dataset. The other training dataset can comprise one or more of a corresponding document type and corresponding field values associated with the second set of documents. The new MLM can be configured to receive an input and in response generate a predicted output. The input for the new MLM can comprise one or more computer-readable tokens corresponding to a target document from one of set of documents 100 and the second set of documents. The predicted output of the new MLM can comprise a corresponding prediction of corresponding document data for the target document.

In some examples, determining whether the second set of documents is of the same document type as set of documents 100 can comprise generating a test predicted output using the first MLM based on a test input comprising one or more computer-readable tokens corresponding to a test document from the second set of documents. This first MLM can be trained using a dataset related to documents from set of documents 100. Next, a confidence score associated with the test predicted output can be generated. Moreover, a further test predicted output using another MLM trained using at least a portion of the second training dataset associated with the second set of documents can be generated. The further test predicted output can be generated based on a further test input comprising one or more corresponding computer-readable tokens corresponding to a further test document from set of documents 100. Furthermore, a further confidence score associated with the further test predicted output can be generated. In addition, it can be determined whether the confidence score and the further confidence score are above a predetermined threshold. If the confidence score and the further confidence score are above the predetermined threshold, the other set of documents can be designated as being of the same document type as set of documents 100. In examples where this technique is applied to first and second document classes instead of document sets, when the confidence score and the further confidence score are above the predetermined threshold, the first class can be designated as being the same or similar to the second class.

In other words, in some examples, determining whether two sets of documents are of the same type can comprise taking a first document from the first set and processing it using a MLM trained using the second set to generate a first prediction having a first confidence score. Next a second document from the second set of documents can be processed using another MLM using trained using the first set to generate a second prediction having a second confidence score. If both the first and second confidence scores are above a predetermined threshold, the two sets of documents can be designated as being of the same type. In some examples, the above-described cross-processing of documents can be performed for multiple documents or a representative sample of documents, before the two sets of documents can be designated as being of the same type.

In some examples, to determine similarity between classes of documents a random sample of verified documents from each document class for each customer group can be taken. This can be done as part of an asynchronous and periodic task. These documents can be evaluated using the document classification models for all customers. Next, the pair of conditional probabilities P(A|B) and P(B|A) that a document is predicted to belong to document class A given that it is predicted to belong to another class B is calculated for every pair of document classes A and B. Only those pairs where the number of predicted documents simultaneously in both classes is over a certain threshold can be kept.

Furthermore, only those pairs where at least one of the conditional probabilities is greater than a certain threshold can be kept. The remaining pairs can be sorted in descending order by the highest of the two conditional probabilities in each pair. The sorted pairs can be iterated from highest to lowest. If the absolute value of the difference of the conditional probabilities of the pair divided by their average (i.e. |P(A|B)−P(B|A)|/AVERAGE(P(A|B), P(B|A))) is below a threshold, then the two document classes can be deemed to be equivalent and a “global” document class can be formed by the union of the pair of classes and the original document classes can be added to the membership of the global class.

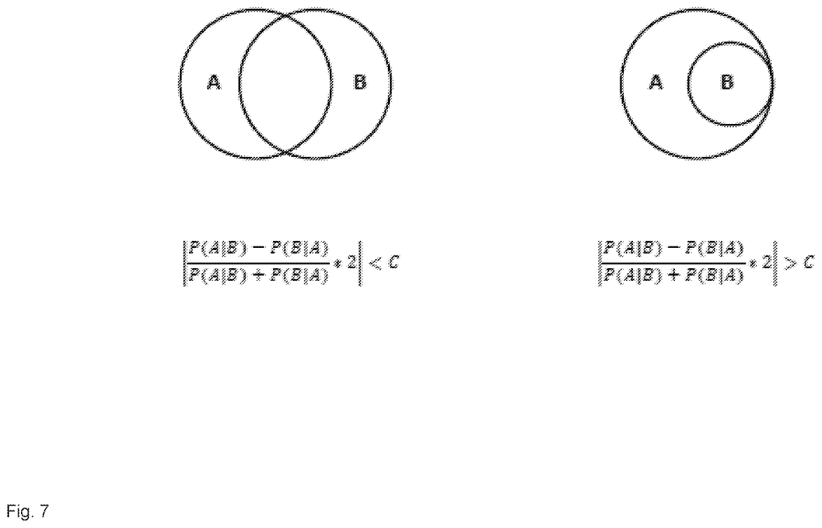

The list can be iterated multiple times, each time updating the pairs of conditional probabilities for the global classes (as the union of all of their member classes) until no more unions occur. Next, the list can be iterated and pairs where the absolute value of the difference of the conditional probabilities divided by their average is above a threshold can be considered to be cases where the class with the higher conditional probability (e.g. class A if P(A|B)>P(B|A)) is considered a subclass of the other class. In this case, if the subclass is a global class with greater than a certain number of members (e.g. 3), then it can be kept as a sub class. If the subclass is not a global class or is a global class with fewer than a certain number of members, it can be merged as a union with the other class. These scenarios are illustrated in FIG. 7 where two existing document classes or global document classes with a high degree of overlap are either merged to form a new global class (the “union” scenario) or kept as a subclass and superclass (the “subclass” scenario).

While document classification was used as an example above, this can also be applied to other classification tasks and to field value extraction.

Once these global classes are created, new MLMs can be trained for each of them using the training datasets of the members of each global class. In this way, classes that are common to multiple customers can be inferred, including finding classes that encompass the superset of a cluster of similar classes (e.g. receipts) and classes that are more specific subsets of a global document class (e.g. meal and expense receipts).

The output from this shared model can be used as input into the models corresponding to the shared model's members (possibly in combination with AMET) to increase the accuracy of the predictions even when a customer has only a small number of verified document classifications/extractions themselves.

The more frequently a document type occurs in multiple instances of the system, the more likely it is that SML can find shared models. As a result, it can be more likely to find a greater number of shared models when there is access to a larger number of different system instances such as in a public cloud-based hosting environment used by multiple groups of customers.

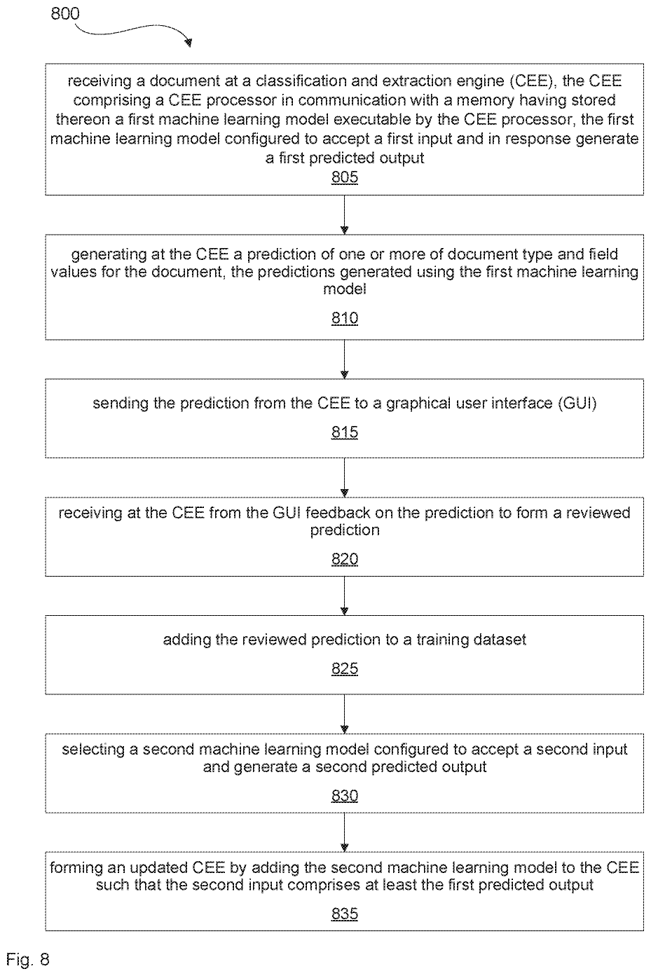

Turning now to FIG. 8, a flowchart is shown representing another method 800 for processing documents. Method 800 can be used to classify documents (e.g. by determining document type) and/or extract field values from the documents. At box 805, a document can be received at a CEE. The CEE can comprise a CEE processor in communication with a memory having stored thereon a first MLM executable by the CEE processor. The first MLM can be configured to accept a first input and in response generate a first predicted output.

At box 810, at the CEE a prediction can be generated of one or more of document type and field values for the document. The predictions can be generated using the first MLM. In some examples, the first input can comprise one or more computer-readable tokens corresponding to the document, and the first predicted output can comprise the prediction of one or more of the document type and the field values for the document.

Moreover, at box 815 the prediction can be sent from the CEE to a GUI. At box 820, in turn, feedback on the prediction can be received at the CEE from the GUI. The feedback can be used to form a reviewed prediction. Furthermore, at box 825 the reviewed prediction can be added to a training dataset. In some examples, the CEE can add the reviewed prediction to the training dataset.

At box 830 a second MLM can be selected, which MLM can be configured to accept a second input and generate a second predicted output. In some examples the selection can be performed at the CEE. The second MLM can have a maximum prediction accuracy corresponding to the training dataset that is larger than a corresponding maximum prediction accuracy of the first MLM corresponding to the training dataset. In addition, at box 835 an updated CEE can be formed by adding the second MLM to the CEE such that the second input comprises at least the first predicted output. Moreover, the second predicted output can comprise one or more of the document type and the field values.

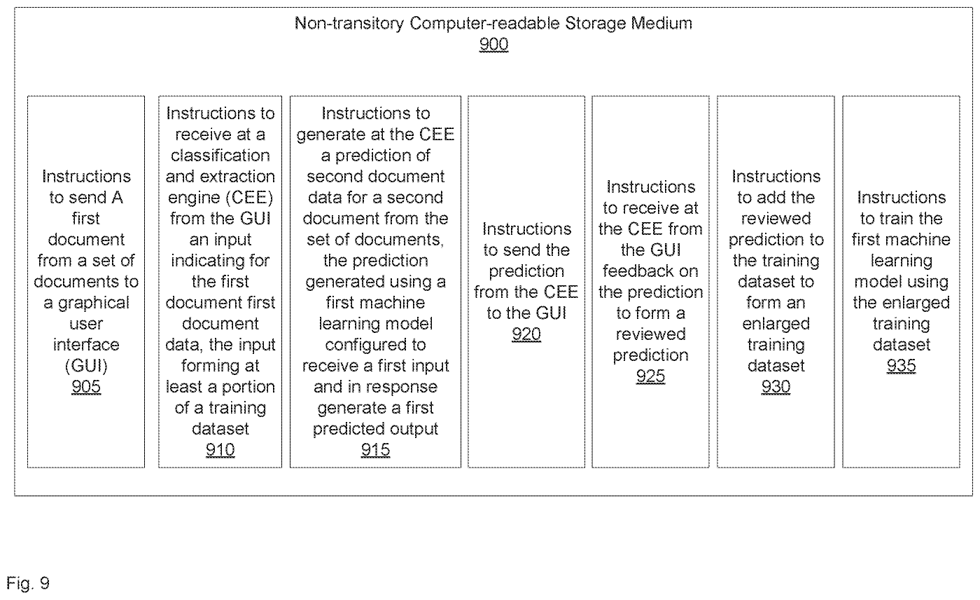

FIG. 9, in turn, shows a schematic representation of a computer-readable storage medium (CRSM) 900 having stored thereon instructions for processing documents. The processing can be used to classify documents (e.g. by determining document type) and/or extract field values from the documents. The CRSM may comprise an electronic, magnetic, optical, or other physical storage device that stores executable instructions. The instructions may comprise instructions 905 to send a first document from a set of documents to a GUI.

The instructions can also comprise instructions 910 to receive at a CEE from the GUI an input indicating for the first document first document data. The input can form at least a portion of a training dataset. Moreover, the instructions can also comprise instructions 915 to generate at the CEE a prediction of second document data for a second document from the set of documents. The prediction can be generated using a first MLM configured to receive a first input and in response generate a first predicted output. The first MLM can be trained using the training dataset. In addition, the first input can comprise one or more computer-readable tokens corresponding to the second document and the first predicted output can comprise the prediction of the second document data.

Furthermore, the instructions can comprise instructions 920 to send the prediction from the CEE to the GUI, and instructions 925 to receive at the CEE from the GUI feedback on the prediction to form a reviewed prediction. Moreover, the instructions can comprise instructions 930 to add the reviewed prediction to the training dataset to form an enlarged training dataset. In some examples, the addition of the reviewed prediction to the training dataset can be performed at the CEE. In addition, the instructions can comprise instructions 935 to train the first MLM using the enlarged training dataset. In some examples, the training can also be performed at the CEE.

The systems, methods, and CRSMs described herein can increase the efficiency and improve the performance at the classification/extraction phases. For example, as described above, AMET can allow tailoring the complexity of the CEE (and its MLM) to both the size of the training dataset and also the complexity of the classification/extraction task. In doing so, the systems, methods, and CRSMs described herein can use a smaller dataset for training the MLM of the CEE.

This smaller training dataset can use less computer-readable memory to store and less processing time and power to train the CEE and its MLM. Moreover, as the complexity of the trained CEE and its MLM can be tailored for achieving the given accuracy at the given classification/extraction task, the amount of memory needed to store the MLM and the amount of processing power and processing time used to run the MLM to perform the classification/extraction can be reduced. As such, the systems, methods, and CRSMs described herein can represent more efficient systems, methods, and CRSMs, in terms of memory and processing power and time used, for classification of documents and extraction of text therefrom.

SML, described above, can also help increase the efficiency of the systems, methods, and CRSMs described herein in terms of the training dataset size and training time used, which can in turn reduce the amount of memory and processing power and time used for training of the MLMs associated with the instant systems, methods, and CRSMs.

While the description herein refers to classification of and extraction of text from documents, it is contemplated that the systems, methods, and CRSMs described herein can also be applied to and/or in the context of bodies, structures, and/or types of data other than documents.

The methods, systems, and CRSMs described herein may include the features and/or perform the functions described herein in association with one or a combination of the other methods, systems, and CRSMs described herein.

It should be recognized that features and aspects of the various examples provided above may be combined into further examples that also fall within the scope of the present disclosure.

1. A method comprising:
receiving at a classification and extraction engine (CEE), from the GUI, a first document from a set of documents and an input indicating for the first document first document data, the input forming at least a portion of a training dataset;
generating at the CEE a prediction of second document data for a second document from the set of documents, the prediction generated using a first machine learning model configured to receive a first input and in response generate a first predicted output, the first machine learning model trained using the training dataset, and wherein the first input comprises one or more computer-readable tokens corresponding to the second document and the first predicted output comprises the prediction of the second document data;
sending the prediction from the CEE to the GUI;
receiving at the CEE from the GUI feedback on the prediction to form a reviewed prediction;
at the CEE adding the reviewed prediction to the training dataset to form an enlarged training dataset; and
at the CEE training the first machine learning model using the enlarged training dataset.

2. The method of claim 1, further comprising before the receipt of the first document from the GUI:
importing at a document preprocessing engine the first document and the second document, the document preprocessing engine comprising a document preprocessing processor in communication with a corresponding memory; and
preprocessing the first document and the second document at the document preprocessing engine to form preprocessed documents, the preprocessing configured to at least partially convert contents of the first document and the second document into computer-readable tokens.

3. The method of claim 1, wherein:
the first document data comprises one or more of a document type of the first document, one or more document fields in the first document, and one or more field values corresponding to the document fields; and
the second document data comprises one or more of a corresponding document type of the second document and one or more corresponding field values for the second document.

4. The method of claim 1, further comprising:
forming an updated CEE by adding a second machine learning model to the CEE, the second machine learning model configured to accept a second input and in response generate a second predicted output, the updated CEE formed such that the second input comprises at least the first predicted output and the second predicted output comprises document data.

5. The method of claim 4, wherein the document data comprises one or more of a corresponding document type of the second document and one or more corresponding field values for the second document.

6. The method of claim 4, wherein the second machine learning model has a maximum prediction accuracy corresponding to the enlarged training dataset that is larger than a corresponding maximum prediction accuracy of the first machine learning model corresponding to the enlarged training dataset.

7-9. (canceled)

10. The method of claim 4, wherein the second input further comprises the one or more computer-readable tokens corresponding to the second document.

11. The method of claim 4, further comprising training the updated CEE using a further training dataset by training the first machine learning model using the further training dataset without training the second machine learning model using the further training dataset.

12. The method of claim 4, further comprising:
forming a further updated CEE by adding a third machine learning model to the updated CEE, the third machine learning model configured to accept a third input and in response generate a third predicted output, the further updated CEE formed such that the second input further comprises the third predicted output.

13. (canceled)

14. The method of claim 1,
wherein the first machine learning model is further configured to generate a confidence score associated with the first predicted output; and
the method further comprising, at the CEE:
designating the prediction for review by an expert reviewer if the confidence score is below a threshold; and
designating the prediction for review by a non-expert reviewer if the confidence score is at or above the threshold.

15. The method of claim 1, wherein:
the first machine learning model is selected from a plurality of machine learning models ranked based on prediction accuracy as a function of a size of the training dataset, the first machine learning model selected to have a highest maximum prediction accuracy corresponding to a size of the training dataset among the plurality of machine learning models.

16. The method of claim 1, further comprising:
determining whether another set of documents is of the same document type as the set of documents; and
if the determination is affirmative, training a further machine learning model using at least a portion of another training dataset associated with the other set of documents and at least a portion of the enlarged training dataset, the other training dataset comprising one or more of a corresponding document type and corresponding field values associated with the other set of documents, the further machine learning model configured to receive a further input and in response generate a further predicted output, the further input comprising one or more computer-readable tokens corresponding to a target document from one of the set of documents and the other set of documents and the further predicted output comprising a corresponding prediction of corresponding document data for the target document.

17. The method of claim 16, wherein the determining whether the other set of documents is of the same document type as the set of documents comprises:
generating a test predicted output using the first machine learning model based on a test input comprising one or more computer-readable tokens corresponding to a test document from the other set of documents;
generating a confidence score associated with the test predicted output;
generating a further test predicted output using a third machine learning model trained using at least a portion of the other training dataset associated with the other set of documents, the further test predicted output generated based on a further test input comprising one or more corresponding computer-readable tokens corresponding to a further test document from the set of documents;
generating a further confidence score associated with the further test predicted output;
determining whether the confidence score and the further confidence score are above a predetermined threshold; and
if the determination is affirmative, designating the other set of documents as being of the same document type as the set of documents.

18. (canceled)

19. A non-transitory computer-readable storage medium comprising instructions executable by a processor, the instructions configured to cause the processor to:
receive at a classification and extraction engine (CEE), from the GUI, a first document from a set of documents and an input indicating for the first document first document data, the input forming at least a portion of a training dataset;
generate at the CEE a prediction of second document data for a second document from the set of documents, the prediction generated using a first machine learning model configured to receive a first input and in response generate a first predicted output, the first machine learning model trained using the training dataset, and wherein the first input comprises one or more computer-readable tokens corresponding to the second document and the first predicted output comprises the prediction of the second document data;
send the prediction from the CEE to the GUI;
receive at the CEE from the GUI feedback on the prediction to form a reviewed prediction;
at the CEE add the reviewed prediction to the training dataset to form an enlarged training dataset; and
at the CEE train the first machine learning model using the enlarged training dataset.

20. A system comprising:
a classification and extraction engine (CEE) comprising a CEE processor in communication with a memory, the memory having stored thereon a first machine learning model executable by the CEE processor, the first machine learning model configured to accept a first input and in response generate a first predicted output;
the CEE configured to:
receive from a Graphical User Interface (GUI) an input indicating first document data for a first document from a set of documents, the input forming at least a portion of a training dataset;
generate a prediction of second document data for a second document from the set of documents, the prediction generated using the first machine learning model trained using the training dataset and wherein the first input comprises computer-readable tokens corresponding to the second document and the first predicted output comprises the prediction of the second document data;
send the prediction to the GUI;
receive from the GUI feedback on the prediction to form a reviewed prediction;
add the reviewed prediction to the training dataset to form an enlarged training dataset; and
train the first machine learning model using the enlarged training dataset.

21. The system of claim 20, further comprising:
a document preprocessing engine comprising a document preprocessing processor in communication with the memory, the document preprocessing engine configured to:
import the first document and the second document; and
process the first document and the second document to form preprocessed documents, the preprocessing configured to at least partially convert contents of the first document and the second document into computer-readable tokens.

22. The system of claim 20, wherein:
the first document data comprises one or more of a document type of the first document, one or more document fields in the first document, and one or more field values corresponding to the document fields; and
the second document data comprises one or more of a corresponding document type of the second document and one or more corresponding field values for the second document.

23. The system of claim 20, wherein the CEE is further configured to:
add a second machine learning model to the CEE, the second machine learning model configured to accept a second input and in response generate a second predicted output, the second input comprising at least the first predicted output and the second predicted output comprising document data.

24. The system of claim 23, wherein the document data comprises one or more of a corresponding document type of the second document and one or more corresponding field values for the second document.

25. The system of claim 23, wherein the second machine learning model has a maximum prediction accuracy corresponding to the enlarged training dataset that is larger than a corresponding maximum prediction accuracy of the first machine learning model corresponding to the enlarged training dataset.

26-28. (canceled)

29. The system of claim 23, wherein the second input further comprises the computer-readable tokens corresponding to the second document.

30. The system of claim 23, wherein the CEE is further configured to train the first machine learning model using a further training dataset without training the second machine learning model using the further training dataset.

31. The system of claim 23, wherein the CEE is further configured to:
add a third machine learning model to the CEE, the third machine learning model configured to accept a third input and in response generate a third predicted output, the second input further comprising the third predicted output.

32. (canceled)

33. The system of claim 20,
wherein the first machine learning model is further configured to generate a confidence score associated with the first predicted output; and
the CEE is further configured to:
designate the predictions for review by an expert reviewer if the confidence score is below a threshold; and
designate the prediction for review by a non-expert reviewer if the confidence score is at or above the threshold.

34. The system of claim 20, wherein:
the memory has stored thereon a plurality of machine learning models ranked based on prediction accuracy as a function of a size of the training dataset; and
the first machine learning model is selected from the plurality of machine learning models to have a highest maximum prediction accuracy corresponding to a size of the training dataset among the plurality of machine learning models.

35. The system of claim 20, wherein the CEE is further configured to:
determine whether another set of documents is of the same document type as the set of documents; and
if the determination is affirmative, train a further machine learning model using at least a portion of another training dataset associated with the other set of documents and at least a portion of the enlarged training dataset, the other training dataset comprising one or more of a corresponding document type and corresponding field values associated with the other set of documents, the further machine learning model configured to receive a further input and in response generate a further predicted output, the further input comprising one or more computer-readable tokens corresponding to a target document from one of the set of documents and the other set of documents and the further predicted output comprising a corresponding prediction of corresponding document data for the target document.

36. The system of claim 35, wherein to determine whether the other set of documents is of the same document type as the set of documents, the CEE is further configured to:
generate a test predicted output using the first machine learning model based on a test input comprising one or more computer-readable tokens corresponding to a test document from the other set of documents;
generate a confidence score associated with the test predicted output;
generate a further test predicted output using a third machine learning model trained using at least a portion of the other training dataset associated with the other set of documents, the further test predicted output generated based on a further test input comprising one or more corresponding computer-readable tokens corresponding to a further test document from the set of documents;
generate a further confidence score associated with the further test predicted output;
determine whether the confidence score and the further confidence score are above a predetermined threshold; and
if the determination is affirmative, designate the other set of documents as being of the same document type as the set of documents.
